(19) United States
(12) Patent Application Publication
(10) Pub. No.: US 2015/0095490 A1
(43) Pub. Date: Apr. 2, 2015

(54) ONLINE SPARSE REGULARIZED JOINT ANALYSIS FOR HETEROGENEOUS DATA

(71) Applicant: NEC Laboratories America, Inc., Princeton, NJ (US)

(72) Inventors: Xia Ning, Indianapolis, IN (US); Jiaji Huang, Durham, NC (US); Guofei Jiang, Princeton, NJ (US)

(21) Appl. No.: 14/503,562

(22) Filed: Oct. 1, 2014

Related U.S. Application Data
(60) Provisional application No. 61/885,568, filed on Oct. 2, 2013.

(51) Int. Cl. H04L 12/26

(52) U.S. Cl. CPC H04L 43/04
USPC 709/224

(57) ABSTRACT

A method and system are provided for online sparse regularized joint analysis for heterogeneous data. The method generates a latent space model modeling a latent space in which correlation information is encoded for a plurality of heterogeneous data points at respective time instants, responsive to respective energy-preserving projections and structure-preserving projections of the data points in the latent space. The method performs online anomaly detection on a current one of the data points responsive to the encoded correlation information for respective ones of the energy-preserving projections and structure-preserving projections for a previous one of the data points without anomaly. The method generates an alarm responsive to a detection of an anomaly for the current one of the data points. The method updates the latent space model for the current one of the data points, by a processor-based online model updater, responsive to a lack of the detection of the anomaly.

### RELATED APPLICATION INFORMATION

This application claims priority to provisional application Ser. No. 61/885,568 filed on Oct. 2, 2013, incorporated herein by reference.

### BACKGROUND

1. Technical Field

The present invention relates to data processing, and more particularly to online sparse regularized joint analysis for heterogeneous data.

2. Description of the Related Art

Online system tracking and anomaly detection have presented significant difficulties given that streaming data is typically fast, high-dimensional and noisy. However, in the era of big data, the heterogeneity of streaming data becomes ubiquitous and makes the online system tracking and anomaly detection even more challenging. In particular, conventional methods that are developed for homogenous data cannot be directly applied for heterogeneous data. Meanwhile, heterogeneous data provides much richer information about the underlying system and thus it becomes critical to understand such data and to discover anomalous behaviors from such data. Efficient and effective techniques for online analysis of heterogeneous data have been highly demanded.

There has been very limited work on the online analysis of heterogeneous data. Most of the existing work focuses on analyzing online homogenous data. For heterogeneous data analysis, there have been some methods developed but in an off-line setting.

Canonical Component Analysis (CCA) has been a canonical method for analyzing heterogeneous data in a principled way. CCA finds a common latent low-dimensional space in which the correlation of heterogeneous data is maximized. Recently, CCA has been adapted in an online setting so as to perform only anomaly detection. However, this adaptive CCA is very expensive computationally.

Principle Component Analysis (PCA) has been a popular method for anomaly detection, and fast online PCA has been well developed and widely used. However, PCA is only useful for homogenous data and cannot be immediately used for heterogeneous data. Meanwhile, PCA is only for tracking linearity. Methods for tracking non-linearity have also been developed but they are very expensive for an online setting.

Some methods from multi-view learning try to tackle similar problems as online heterogeneous data analysis and existing methods include Procrustes analysis, multiple kernel learning, transfer learning, manifold alignment, graphical models and principle subspace tracking, Bayesian analysis, and so forth. Most of the work is for off-line setting, whereas two of these methods are most relevant for online setting. The first of these two methods looks for a combination of PCA and CCA subspace for system tracking, whereas the second of these two methods models the system and heterogeneous data sources via Gaussian processes and shared/personal structures.

### SUMMARY

These and other drawbacks and disadvantages of the prior art are addressed by the present principles, which are directed to online sparse regularized joint analysis for heterogeneous data.

According to an aspect of the present principles, a method is provided for online sparse regularized joint analysis for heterogeneous data. The method includes generating a latent space model modeling a latent space in which correlation information is encoded for a plurality of heterogeneous data points at respective ones of a plurality of time instants, responsive to respective energy-preserving projections and structure-preserving projections of the heterogeneous data points in the latent space. The method further includes performing online anomaly detection on a current one of the plurality of heterogeneous data points responsive to the encoded correlation information for respective ones of the energy-preserving projections and structure-preserving projections for a previous one of the plurality of heterogeneous data points without anomaly. The method also includes generating an alarm responsive to a detection of an anomaly for the current one of the plurality of heterogeneous data points. The method additionally includes updating the latent space model for the current one of the plurality of heterogeneous data points, by a processor-based online model updater, responsive to a lack of the detection of the anomaly.

According to another aspect of the present principles, a system is provided for online sparse regularized joint analysis for heterogeneous data. The system includes a latent space model generator for generating a latent space model modeling a latent space in which correlation information is encoded for a plurality of heterogeneous data points at respective ones of a plurality of time instants, responsive to respective energy-preserving projections and structure-preserving projections of the heterogeneous data points in the latent space. The system further includes an online anomaly detector for performing online anomaly detection on a current one of the plurality of heterogeneous data points responsive to the encoded correlation information for respective ones of the energy-preserving projections and structure-preserving projections for a previous one of the plurality of heterogeneous data points without anomaly. The system also includes an alarm generator for generating an alarm responsive to a detection of an anomaly for the current one of the plurality of heterogeneous data points. The system additionally includes a processor-based online latent space model updater for updating the latent space model for the current one of the plurality of heterogeneous data points, responsive to a lack of the detection of the anomaly.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram showing an exemplary processing system 100 to which the present principles may be applied, according to an embodiment of the present principles;

FIG. 2 is a block diagram showing an exemplary system 200 for online sparse regularized joint analysis for heterogeneous data, in accordance with an embodiment of the present principles;

FIG. 3 is a diagram showing an exemplary projection 300 into latent space, in accordance with an embodiment of the present principles;

FIG. 4 is a flow diagram showing an exemplary method 400 for performing online system updating, in accordance with an embodiment of the present principles;

FIG. 5 is a flow diagram showing an exemplary method 500 for performing energy-preserving projector updates, in accordance with an embodiment of the present principles;

FIG. 6 is a flow diagram showing an exemplary method 600 for performing structure-preserving projector updates, in accordance with an embodiment of the present principles; and

FIG. 7 is a flow diagram showing an exemplary method 700 for online anomaly detection, in accordance with an embodiment of the present principles.

### DETAILED DESCRIPTION OF PREFERRED EMBODIMENTS

The present principles are directed to online sparse regularized joint analysis for heterogeneous data.

The present principles provide a new system and methods for online heterogeneous data analysis. The present principles discover the latent space that captures most of the inherent relations among all heterogeneous data sources and also enables anomaly detections from the latent space. Our system and methods are fully online and adaptive to system dynamics with very limited human surveillance and domain knowledge.

Our system and methods rely on the learning of a latent space via two projectors from heterogeneous data into the space. One projector preserves most of the signals (and thus the energies) into the latent space from one data source, and is thus referred to herein as the “energy-preserving projector”. The other projector captures most of the structures in the other data source as well as the structures in the latent space among all the data sources, and is thus referred to herein as the “structure-preserving projector”. These two projectors are learned purely from the streaming data in an online fashion, and thus they can adapt to system dynamics. Meanwhile, due to the nature of these two projectors, anomalies can be effectively detected based on the latent space.

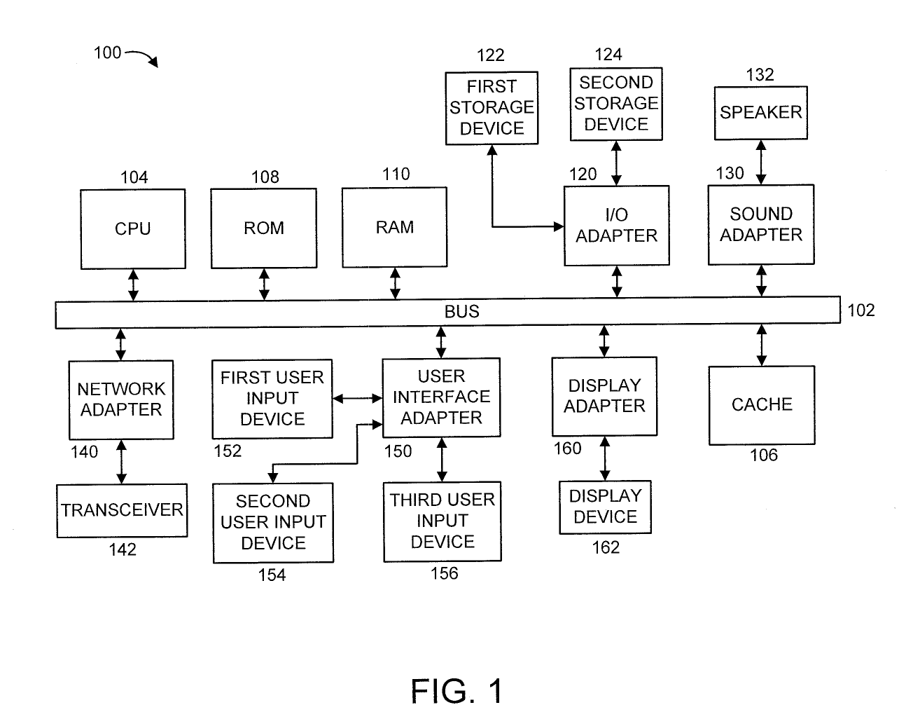

FIG. 1 shows an exemplary processing system 100 to which the present principles may be applied, according to an embodiment of the present principles. The processing system 100 includes at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102.

A first storage device 122 and a second storage device 124 are operatively coupled to system bus 102 by the I/O adapter 120. The storage devices 122 and 124 can be any of a disk storage device (e.g., a magnetic or optical disk storage device), a solid state magnetic device, and so forth. The storage devices 122 and 124 can be the same type of storage device or different types of storage devices.

A speaker 132 is operatively coupled to system bus 102 by the sound adapter 130. A transceiver 142 is operatively coupled to system bus 102 by network adapter 140. A display device 162 is operatively coupled to system bus 102 by display adapter 160.

A first user input device 152, a second user input device 154, and a third user input device 156 are operatively coupled to system bus 102 by user interface adapter 150. The user input devices 152, 154, and 156 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The user input devices 152, 154, and 156 can be the same type of user input device or different types of user input devices. The user input devices 152, 154, and 156 are used to input and output information to and from system 100.

Of course, the processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present principles provided herein.

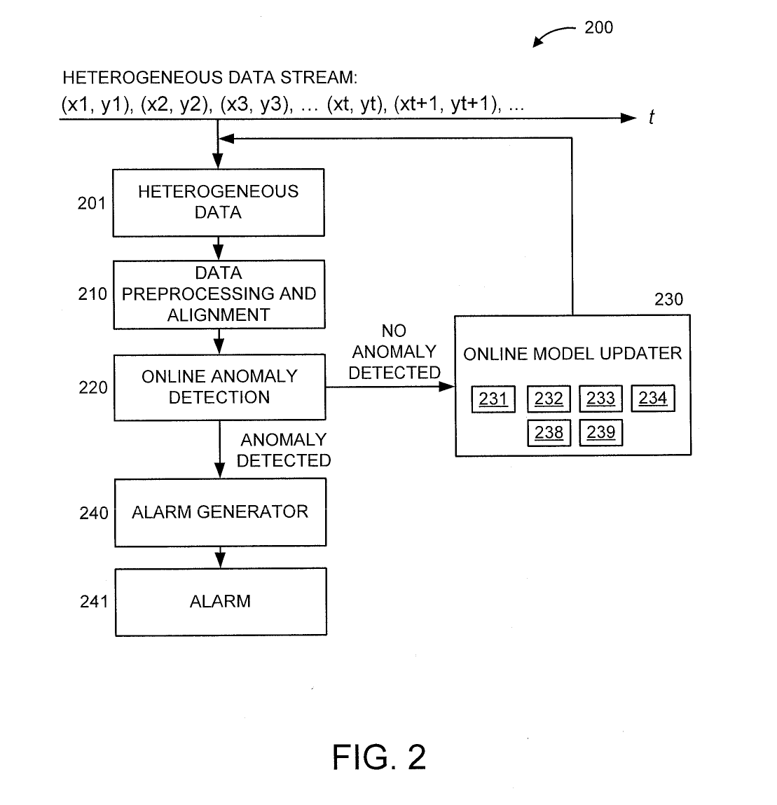

Moreover, it is to be appreciated that system 200 described below with respect to FIG. 2 is a system for implementing respective embodiments of the present principles. Part or all of processing system 100 may be implemented in one or more of the elements of system 200.

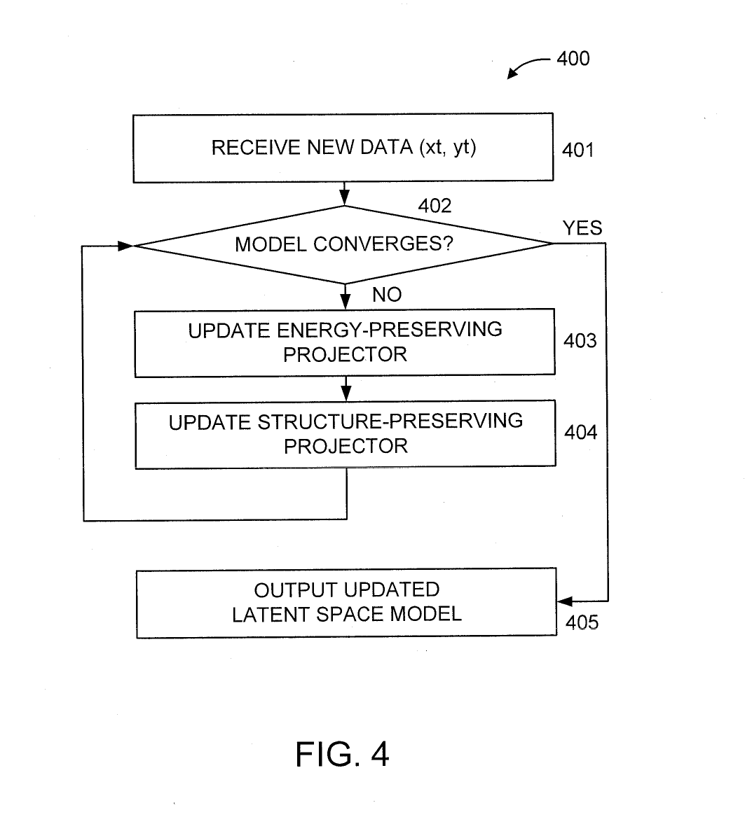

Further, it is to be appreciated that processing system 100 may perform at least part of the methods described herein including, for example, at least part of methods 400-700 of FIGS. 4-7, respectively. Similarly, part or all of system 200 may be used to perform at least part of methods 400-700 of FIGS. 4-7, respectively.

FIG. 2 shows an exemplary system 200 for online sparse regularized joint analysis for heterogeneous data, in accordance with an embodiment of the present principles. The system 200 includes a data pre-processor and aligner 210, an online anomaly detector 220, an online model updater 230, and an alarm generator 240.

In an embodiment, the online model updater 230 includes an energy-preserving projector 231, an energy-preserving projector updater 232, a structure preserving projector 233, and a structure-preserving projector updater 234. The energy-preserving projector 231 generates an energy-preserving projection for use by a latent space model 239. The structure-preserving projector generates a structure-preserving projection for use by the latent space model 239. Given their relation, the terms “projector” and “projection” can be used interchangeably herein. In an embodiment, at least the energy-preserving projection updater 232 and the structure-preserving projection updater 234 are processor-based. In another embodiment, the online model updater 230 includes a processor (e.g., a centralized processor) accessible by the elements of the online model updater 230. In an embodiment, the online model updater 230 can also initially create the latent space model 239, as well as update the latent space model 239. In an embodiment as shown in FIG. 2, the online model updater 230 includes a latent space model generator 238. In another embodiment, the latent space generator 238 is a separate entity. In another embodiment, the initial latent space model is received by an external component with respect to system 200, for use by (including updating) system 200. In an embodiment, the latent space model 239 is shown within the online model updater 230. In another embodiment, the online model updater 230 accesses the latent space model 239 from another entity/location. These and other variations to the online model updater 230, as well as the other elements of system 200, are readily determined by one of ordinary skill in the art, while maintaining the spirit of the present principles.

The system 200 operates on heterogeneous streaming input data 201: (x1, y1), (x2, y2), (x3, y3), . . . , (xt, yt), (xt+1, yt+1), . . . , that is, at each time stamp t, there comes a new heterogeneous data point (xt, yt), where xt and yt may have different format (e.g., time series and log files, numerical values and categorical values, and so forth). Given the new coming data point, the system 200 first conducts a data preprocessing and alignment using the data pre-processor and aligner 210 so as to format the data for the system 200.

The online model updater 230 performs the online model updates, that is, the learning and search for the two projectors 231 and 233 which transfer the input data into a latent space, using the normal data that passes the anomaly detector 220. The two projectors 231 and 233 are referred to herein as the energy-preserving projector 231 (U) and the structure-preserving projector 233 (V), both of which together define a latent low-dimensional space which preserve most of the data energy and meanwhile the structures that best describe the relations of the heterogeneous data.

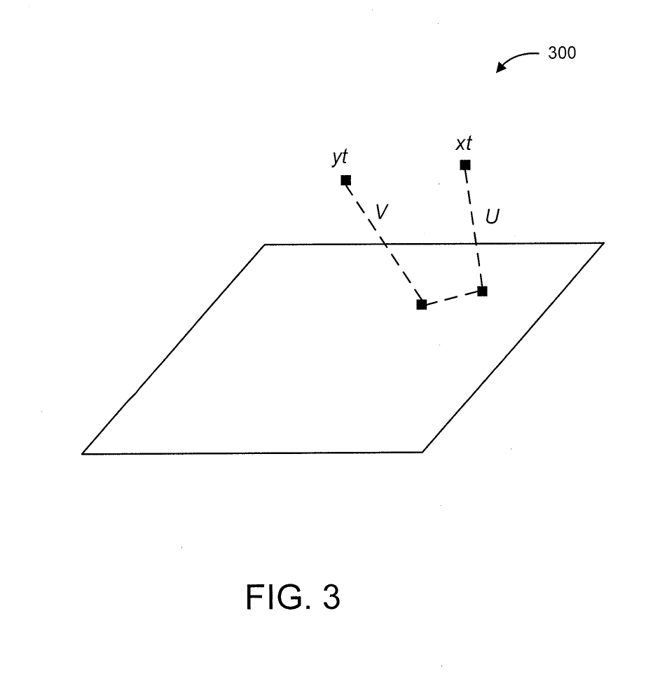

Referring now to FIG. 3, the same shows an exemplary projection 300 into latent space, in accordance with an embodiment of the present principles. The latent space is the place where the most critical information and relation of xt and yt are encoded. We generate a mathematical model, also hereinafter referred to as the “latent space model”, based on the projection 300 as follows. The latent space model finds the latent space defined by U and V using (solving) an optimization problem as follows:

$${min}_{U , V} F ( U , V ; t , α , σ , λ ) = {min}_{U , V} {\sum }_{k = 0}^{t - 1} \frac{{α}^{k}}{2} ( {\vert \vert {U}^{T} {x}_{t - k} - {V}^{T} {y}_{t - k} \vert \vert}^{2} + σ {\vert \vert ( I - {UU}^{T} ) {x}_{t - k} \vert \vert}^{2} ) + λ {\vert \vert V \vert \vert}_{1 , 2}$$

$$s . t . {U}^{T} U = I$$

where U,V projects the heterogeneous views, x_t and yt into the assumed latent space, Alpha is a weighing factor between 0 and 1 to wash out the memory of historical data, the “Sigma” term enforces the low rank property of x_t, and the “lambda” term encourages sparsity of effective features in y_t.

The latent space model applies a sliding window of size k along the time line with exponential decay using the parameter a. The latent space model looks for the latent space in which the most signals, and thus the energy of xt, is preserved. The term ∥(I−UU^{T})xt−k∥² measures the energy loss. Meanwhile, the structure of the latent space is measured by the distance between the projections, which is quantitated by the term ∥U^{T}xt−k−V^{t}yt−k∥², as well as the term ∥V∥_{1,2} which automatically performs sparsification on V.

The latent space model is important since its quality directly impacts all the consecutive detection qualities. Once the latent space model is updated by the online model updater 230, the latent space model is used at the next time stamp t+1. This is an iterative online process.

Further regarding the latent space model itself, in addition to advantageously working for an online setting, the latent space model works for dynamic cases, and provides better results over the prior art for difficult situations such as when drift is more frequent.

Referring back to FIG. 2, the online anomaly detector 220 performs online anomaly detection given the preprocessed data. The anomaly detection is online, based on the two projectors 231 and 233 learned from previous normal data.

The alarm generator 240 generates an alarm 241. The alarm 241 is generated responsive to the detection of an anomaly.

Further regarding system 200, our approach discovers the latent relations among heterogeneous data by looking for a latent space and two projections into the latent space, and the projections are dynamically updated upon the arrival of normal data. Compared to prior art approaches, our approach is more scalable to large systems and high-dimensional data, provides faster online updates, and is faster in adapting to system dynamics.

FIG. 4 shows an exemplary method 400 for performing online system updating, in accordance with an embodiment of the present principles. Method 400 corresponds to the online model updater 230 of FIG. 2. Note that following step 301 represents providing the input (heterogeneous data) 201 of system 200 as an input to method 400.

In general, the online model updater 230 learns the latent space model and updates the latent space model upon the arrival of each normal data, which serves as the core of system 200.

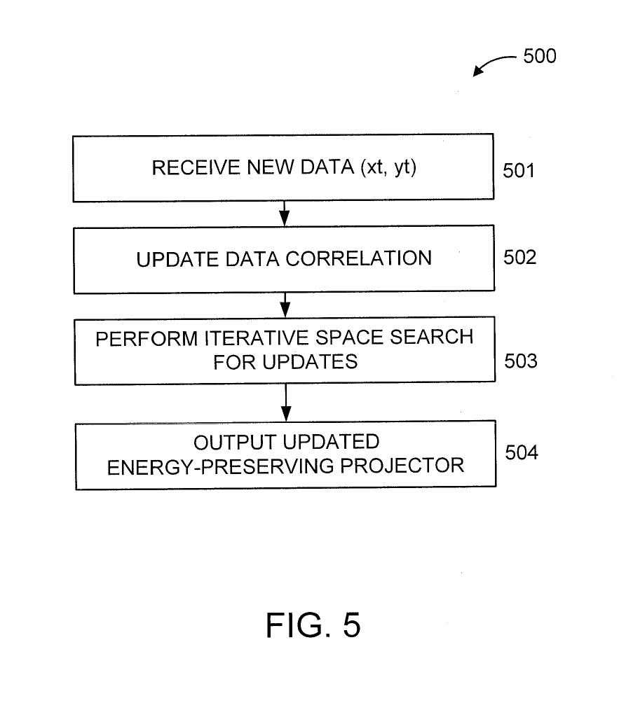

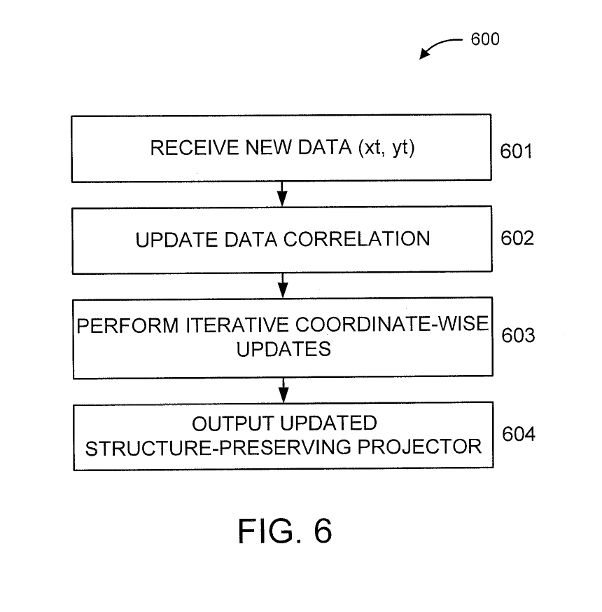

At step 401, (new) heterogeneous data (xt, yt) is received. At step 402, it is determined if the latent space model converges. If so, the method 400 proceeds to step 405. Otherwise, the method 400 proceeds to step 403. At step 403, the energy-preserving projector 231 is updated. At step 404, the structure-preserving projector 433 is updated. Steps 403 and 404 are performed iteratively, and a convergence test (per step 402) is performed after each of the iterations. Upon the convergence of the iterations, the updated latent space model is output at step 405 ready to be used for the next time stamp. The details of updating (per step 403) the energy-preserving projector 231 are described in further detail with respect to FIG. 5, and details of updating (per step 404) the structure-preserving projector 233 are described in further detail with respect to FIG. 6.

FIG. 5 shows an exemplary method 500 for performing energy-preserving projector updates, in accordance with an embodiment of the present principles. Method 500 corresponds to the energy-preserving projector updater 232 of FIG. 2, as well as step 403 of FIG. 4. Note that following step 501 represents providing the input (heterogeneous data) 201 of system 200 as an input to method 500.

At step 501, (new) heterogeneous data (xt, yt) is received. At step 502, data correlation is updated by cumulating the new input data. Also the projection of yt into the latent space via the structure-preserving projector 233 is calculated, which will be used in the energy-preserving projector updates. At step 503, an efficient space search algorithm is performed to update the energy-preserving projector 231. At step 504, the updated energy-preserving protector is output. A majorization function is designed so as to guide the efficient space search of the energy-preserving projector towards its local optima within only a few steps via a set of Singular Value Decomposition (SVD) applied on the combination of data correlation and structure-preserving projection of yt. While method 500 is described as involving a majorization function, it is to be appreciated that other functions and/or methods can be used. For example, any other functions and/or methods which are fast in an online setting and able to find the optimal solutions of the projector updates can be used in accordance with the teachings of the present principles, while maintaining the spirit of the present principles.

FIG. 6 shows an exemplary method 600 for performing structure-preserving projector updates, in accordance with an embodiment of the present principles. Method 600 corresponds to the structure-preserving projector updater 234 of FIG. 2, as well as step 404 of FIG. 4. Note that following step 601 represents providing the input (heterogeneous data) 201 of system 200 as an input to method 600.

At step 601, (new) heterogeneous data (xt, yt) is received. At step 602, data correlation is updated by cumulating the new input data. At step 603, an iterative stochastic coordinate descent approach is performed to update the structure-preserving projector 233 in a series of coordinate-wise iterations. At step 604, the updated structure-preserving projector 233 is output. The structure-preserving projector 233 has an automatic feature selection mechanism via a sparsity constraint on the structure-preserving projector 233, and the stochastic coordinate descent approach takes advantages of this constraint so as to quickly converge to an optimal solution of the update. Meanwhile, this stochastic approach is able to quickly adapt to system dynamics when the structure-preserving projector 233 drifts from one to another. This stochastic coordinate descent approach (per step 603) is sufficiently fast for an online method.

Further regarding methods 400, 500, and 600, the updates for the energy-preserving projector 231 are guided by another process (i.e., the majorization function) in an iterative fashion. The updates for the structure-preserving projector are customized to the latent space model with a feature selection mechanism and they are very fast.

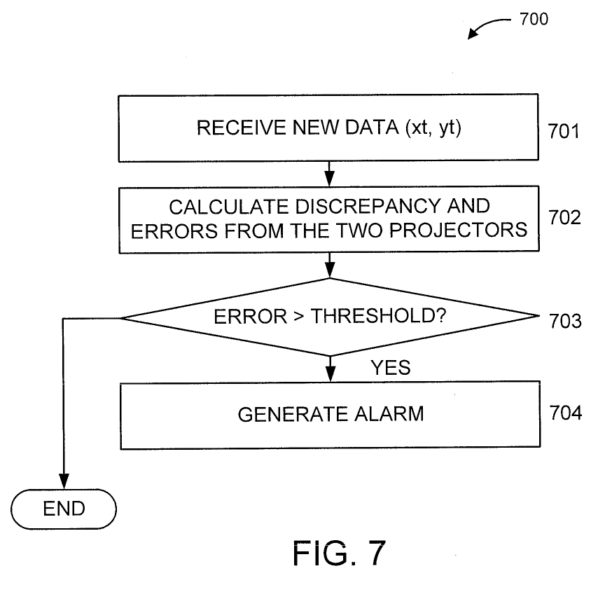

FIG. 7 shows an exemplary method 700 for online anomaly detection, in accordance with an embodiment of the present principles. Method 700 corresponds to the online anomaly detector 220 of FIG. 2. Note that following step 701 represents providing the input (heterogeneous data) 201 of system 200 as an input to method 700.

At step 701, (new) heterogeneous data (xt, yt) is received. At step 702, given the updated model from the previous methods 500 and 600, new detection statistics are calculated based on the two projectors 231 and 233, which capture the discrepancy and projection errors of the data point into the latent space via the two projectors 231 and 233. At step 703, a moving average scheme is leveraged to test whether the detection stats is above a threshold. If so, then the method 700 proceeds to step 704. Otherwise, the method 700 is terminated. At step 704, an alarm 241 is generated. This anomaly detection scheme is fully customized for the proposed latent space method with the two projectors 231 and 233, which has specific semantics in explaining the system behaviors, and thus can serve as knowledge discovery tools in the online setting.

Further regarding method 700, the anomaly detection statistics are fully customized to the latent space model. Also, the online anomaly detector can use semantic meanings in explaining the relations among heterogeneous data and detect anomalies based on the same. This semantic meaning provides much wider use scenarios for our method as a knowledge discovery tool.

A description will now be given of some of the many attendant competitive/competitive values of the present principles.

The present principles are able to achieve online detection performance at a high level. The system is an online system that is fully adaptive with very limited domain knowledge and human surveillance, and thus general enough for various systems and applications. Thus, it is expected that deployment of such a system is able to significantly reduce the cost and time for performing anomaly detections.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable medium such as a semiconductor or solid state memory, magnetic tape, a removable computer diskette, a random access memory (RAM), a read-only memory (ROM), a rigid magnetic disk and an optical disk, etc.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention.

What is claimed is:

1. A method for online sparse regularized joint analysis for heterogeneous data, comprising:
generating a latent space model modeling a latent space in which correlation information is encoded for a plurality of heterogeneous data points at respective ones of a plurality of time instants, responsive to respective energy-preserving projections and structure-preserving projections of the heterogeneous data points in the latent space;
performing online anomaly detection on a current one of the plurality of heterogeneous data points responsive to the encoded correlation information for respective ones of the energy-preserving projections and structure-preserving projections for a previous one of the plurality of heterogeneous data points without anomaly;
generating an alarm responsive to a detection of an anomaly for the current one of the plurality of heterogeneous data points; and
updating the latent space model for the current one of the plurality of heterogeneous data points, by a processor-based online model updater, responsive to a lack of the detection of the anomaly.

2. The method of claim 1, wherein the latent space model is updated using a majorization function configured to guide a space search on the latent space model towards a local optima.

3. The method of claim 2, wherein the latent space model is updated further using a Singular Value Decomposition applied to a combination of latent variable information and at least a respective one of the structure-preserving projections.

4. The method of claim 1, wherein the latent space model models the latent space by applying a sliding window of size k along a time line with an exponential decay.

5. The method of claim 1, wherein the latent space model is iteratively updated in each of a plurality of iterations that each update one or more of the energy-preserving projections and one or more of the structure preserving projections.

6. The method of claim 1, wherein the latent space model includes a term measuring a heterogeneous data point energy loss relating to at least one of the heterogeneous data points.

7. The method of claim 1, wherein the latent space model includes a term representing a structure of the latent space measured by a distance between corresponding ones of the energy-preserving projections and the structure-preserving projections.

8. The method of claim 1, further comprising performing sparsification on the plurality of structure-preserving projections.

9. The method of claim 1, wherein the latent space model is updated using an iterative stochastic coordinate descent technique that updates in a series of coordinate-wise iterations.

10. The method of clam 9, further comprising assisting convergence of the stochastic coordinate descent technique using a sparsity constraint.

11. A non-transitory article of manufacture tangibly embodying a computer readable program which when executed causes a computer to perform the steps of claim 1.

12. A system for online sparse regularized joint analysis for heterogeneous data, comprising:
a latent space model generator for generating a latent space model modeling a latent space in which correlation information is encoded for a plurality of heterogeneous data points at respective ones of a plurality of time instants, responsive to respective energy-preserving projections and structure-preserving projections of the heterogeneous data points in the latent space;
an online anomaly detector for performing online anomaly detection on a current one of the plurality of heterogeneous data points responsive to the encoded correlation information for respective ones of the energy-preserving projections and structure-preserving projections for a previous one of the plurality of heterogeneous data points without anomaly;
an alarm generator for generating an alarm responsive to a detection of an anomaly for the current one of the plurality of heterogeneous data points; and
a processor-based online latent space model updater for updating the latent space model for the current one of the plurality of heterogeneous data points, responsive to a lack of the detection of the anomaly.

13. The system of claim 12, wherein the latent space model is updated using a majorization function configured to guide a space search on the latent space model towards a local optima.

14. The system of claim 13, wherein the latent space model is updated further using a Singular Value Decomposition applied to a combination of latent variable information and at least a respective one of the structure-preserving projections.

15. The system of claim 12, wherein the latent space model models the latent space by applying a sliding window of size k along a time line with an exponential decay.

16. The system of claim 12, wherein the latent space model is iteratively updated in each of a plurality of iterations that each update one or more of the energy-preserving projections and one or more of the structure preserving projections.

17. The system of claim 12, wherein the latent space model includes a term measuring a heterogeneous data point energy loss relating to at least one of the heterogeneous data points.

18. The system of claim 12, wherein the latent space model includes a term representing a structure of the latent space measured by a distance between corresponding ones of the energy-preserving projections and the structure-preserving projections.

19. The system of claim 12, wherein the processor-based online latent space model updater performs sparsification on the plurality of structure-preserving projections.

20. The system of claim 12, wherein the latent space model is updated using an iterative stochastic coordinate descent technique that updates in a series of coordinate-wise iterations.
